(19) United States
(12) Patent Application Publication
(10) Pub. No.: US 2018/0327307 A1
(43) Pub. Date: Nov. 15, 2018

(54) Method for Obtaining Microcements for Injection Grouts and Microcement Obtained

(71) Applicant: Cementos Argos S.A., Medellin (CO)

(72) Inventors: Samuel Eduardo Arango Ocampo, Medellin (CO); Adolfo Leon Gomez, Medellin (CO)

(21) Appl. No.: 15/777,440

(22) PCT Filed: Nov. 18, 2016
(86) PCT No.: PCT/IB2016/056975

§ 371 Date: May 18, 2018

(30) Foreign Application Priority Data
Nov. 19, 2015 (CO) 15-276801

(51) Int. Cl. C04B 7/52; C04B 7/02

(52) U.S. Cl. CPC C04B 7/522; C04B 18/06; C04B 7/02

(57) ABSTRACT

A method for obtaining microcement and the microcement obtained thereof, by means of using a closed-circuit mill with high-efficiency separators (second generation with cyclones for dust collection), thus allowing to produce at a very low cost, showing excellent properties and quality of the microcement obtained thereof.

### PRIOR ART

### Field of the Invention

The present invention is related to the field of cement industry, particularly referring to a method for obtaining microcements for high added value injection grouts, taking advantage of ultrafine grinds that are present in a closed milling circuit with high-efficiency separators, which otherwise these ultrafine grinds would be part of a product with very low market value. Likewise, a high performance microcement is provided, which satisfies the requirements for the manufacture of injection grouts with high fluidity, adequate stability and setting times.

### Description of Prior Art

In order to better understand the objective and scope of the subject invention, it is convenient to describe the prior art relating to microcements and the inconveniences that arise.

Microcements are well known in the art and it is known that they have a particle size much smaller than that of conventional cement which gives it the ability to function adequately with high water-cement ratios, great penetration capacity in reduced spaces, adequate development of resistance and higher setting speed, all this being advantageous for the production of injection grouts. Generally, microcements have the same characteristics than Portland cement, and they prove to be cements without any additives that can manage to achieve fast setting times with high water-cement ratios, required for their application.

On the other hand, cement grouts are homogeneous mixtures of Portland cement, water and additives, of which distinct features are demanded of. As an example, in a plastic state, they require high fluidity and stability, and low exudation, while during the setting process, they require accelerated setting and low bulk variation. After hardening, they also must show compressive strength. Likewise, cement grouts can be injected into soils and rocks to consolidate, stagnate, stabilize and waterproof; to rehabilitate structures, filling in fissures and porosities, leaks and to increase strengths; in oil & gas wells to perform isolation and hydraulic seal.

It is emphasized, that some cement grouts require special properties, for example those used for waterproofing and/or consolidation pre-injections, which are achieved by using special cements, such as microcements. Referring again to microcement, in order to obtain said microcement, the cement particle must be “broken” in order to obtain smaller sizes. It is a very finely ground cement, therefore obtaining, a material that has unique properties to be injected and to generate conditions for consolidation and waterproofing.

However, the processes or stages for obtaining microcements in general, involve high levels of complexity during grinding leading to excessive cost of the final product, given high energy consumption and equipment wear.

Therefore, as far as prior art is concerned for obtaining microcements, it would be very convenient to have a new method of obtaining microcements that could reduce related costs, energy consumption and equipment wear, in addition to obtaining a product with adequate properties and quality.

### BRIEF DESCRIPTION OF THE INVENTION

It is therefore an objective of the subject invention to provide a new method for obtaining microcements for high added value injection grouts, taking advantage of ultrafine grinds that are present in a closed milling circuit with high-efficiency separators, which otherwise these ultrafine grinds would be part of a product with very low market value.

It is still another objective of the present invention to provide a method that uses second generation separators, with cyclones for dust collection, as means of obtaining the microcement.

It is also another objective of the present invention to provide a method that maintains the amount of electric power consumption and equipment wear, within levels of a conventional cement production system.

It is still another objective of the present invention to provide a method for obtaining microcements that complies with the properties.

It is also another objective of the present invention to provide a method for obtaining microcements for injection grouts through a grinding system that uses a mill connected to a high-efficiency separator (second generator cyclones for dust collection), wherein the method comprises the stages of: providing raw materials for the mill until a determined particle size is obtained, feeding the high-efficiency separator (second generator cyclones for dust collection) at the top with the ground raw materials, supplying the high-efficiency separator with an air current through an external fan and generating the recirculation of said air current, separating the coarse material by means of aspiration inside the separator's main housing with the air current or flow, discharging the fine material through the top part of the housing with the air flow, moving the fine material to a plurality of cyclones through a gas conduct, separating the fine material in the cyclones until a fraction of ultrafine material is obtained, discharging the remaining fine material through the lower part of the cyclones to aeration conveyors, moving a part of the air together with the fraction of ultrafine material from the cyclones to a sleeve filter, and extracting said fraction of ultrafine material from the filter.

It is still another objective of the subject invention to provide a microcement for injection grouts of the kind used in bridges, pavement, dams, prefabricated materials, foundations, stand-alone pieces, tunnels, mining and/or oil & gas wells, which comprises between 30 and 95% by weight of Portland cement clinker, between 2% to 6% by weight of plaster, and between 0% and 70% by weight of limestone, slag, ash or pozzolan.

### DETAILED DESCRIPTION OF THE INVENTION

Referring now to the invention, it consists of a new method for obtaining microcements for injection grouts that uses grinding systems with high-efficiency separators, which allows for a more practical and efficient method taking advantage of a very fine fraction of ground cement (microcement), that if it were not extracted, it would be part of the cement obtained in the grinding, delivering a microcement with adequate properties for its application in higher value injection grouts.

Firstly, reference will be made to the known closed circuits of cement grinding with high-efficiency separators (second generation with cyclones for dust collection) for exemplary purposes and to facilitate understanding of the present invention. Therefore, the closed-circuit mills with high efficiency separators (second generation with cyclones for dust collection) have the capability of fractioning and mixing raw materials down to an adequate particle size. Subsequently, this material is fed to the separator through a distribution disk, which by means of the air current and rotation forces (gravity and centrifuge forces) makes a separation between fine and coarse particles. The coarse particles return to the mill, while the separation air current, which is mixed with the fine particles (product obtained from the grinding), goes to the dust collection system of the separator materialized by cyclones, where the air current is separated from the material (final product). Upon air extraction, ultrafine material is dragged, which finally materializes the microcement.

As mentioned above, the method of the invention is characterized by using said high-efficiency separators (second generation with cyclones for dust collection) by which the microcement is separated from the cement that is being ground. This microcement, compared with microcement produced by grinding dedicated exclusively to its production, presents an important reduction in related costs.

Thus, the method for obtaining microcement for injection grouts comprises a first stage of grinding the cement raw materials to a suitable particle size, where subsequently said material is fed through the top of the separator. Once the ground material is inside the separator, an air current is supplied through an external fan, and recirculation of said air current is generated to assure a constant flow that allows for continuous separation of coarse material from fine material as the separator is fed with raw material. The separation process from the coarse material is produced by suction inside the main housing using air flow. During the aforementioned separation, the fine material is moved and discharged at the top part of the housing with the air flow, while the coarse material falls by gravity towards the bottom of a discharge hopper and exits the same through a pendulum valve.

Referring again to the method of the invention, the fine material that arrives from the high-efficiency separator is moved to a plurality of cyclones through a gas conduct. Within the cyclones, the fine material is separated until a fraction of ultrafine material is obtained. The separation of the fine material is achieved through an air vortex generated inside the cyclones. Thus, the remaining fine material is discharged at the bottom of the cyclones onto the aeration conveyors which transport the fine material for later packaging. The remaining fine material is what known as “cement”. On one hand, the ultrafine fraction moves to a sleeve filter by the generated air, thereby retaining the ultrafine fraction for later extraction that is achieved through a forced air stream. It is highlighted that the ultrafine fraction that is extracted from the sleeve filter is the microcement itself.

As an example, but not limiting the scope of the invention, using a raw material feed current to the mill of 43 tph (100%), fine material is obtained, i.e., cement final product of 42.5 tph (98.8%) and ultrafine material (microcement) of 0.5 tph (2.12%).

Likewise, in another embodiment, a microcement can be obtained for injection grouts of the type used in bridges, pavements, dams, prefabricated materials, foundations, stand-alone projects, tunnels, mining projects and/or oil & gas wells, which consists of:

30 to 95% by weight of Portland cement clinker,

2% to 6% by weight of plaster, and

0% to 70% by weight of limestone, slag, ash or pozzolan.

In a second embodiment, a microcement for injection grouts can be obtained using the method of the invention which consists of:

88% by weight of Portland cement clinker,

5% by weight of plaster, and

7% by weight of limestone, slag, ash or pozzolan.

Given the microcement can show a maximum particle size ranging between 15 to 25 microns in said embodiments, it is highlighted that the microcement, with its respective components and percentages mentioned above, do not limit the invention. Other percentages can be used without departing from the scope of the invention.

Having thus specifically described the subject invention, and the manner in which it must be put into practice, the following is claimed:

1. A method for obtaining microcement for injection grouts through the use of a grinding system that utilizes a mill connected to a high-efficiency separator (second generation with cyclones for dust collection), wherein the method comprises the stages of:
providing raw material to the mill and grind until a determined particle size is obtained,
feeding the high-efficiency separator (second generation with cyclones for dust collection) at the top part with the ground raw material,
supplying the high-efficiency separator with an air current through an external fan and generating the recirculation of said air current,
separating the coarse material through suction inside the main housing of the separator with the air flow or current,
discharging the fine material through the top part of the housing with the air flow,
moving such fine material to a plurality of cyclones through a gas conduct,
separating the fine material inside the cyclones until a fraction of ultrafine material is obtained,
discharging the remaining fine material through the top part of the cyclones onto aeration conveyors,
moving a part of the air current together with the fraction of ultrafine material from the cyclones to a sleeve filter, and
extracting such ultrafine material fraction from the filter.

2. A method for obtaining microcement according to claim 1, wherein the coarse material is discharged at the bottom part of a discharge hopper through a pendulum valve.

3. A method for obtaining microcement according to claim 1, wherein the ultrafine material is extracted from the sleeve filter by a forced air current.

4. Microcement for injection grouts of the type used in bridges, pavements, dams, prefabricated materials, foundations, stand-alone projects, tunnels, mining projects and/or oil & gas wells, which comprises:
30 to 95% by weight of Portland cement clinker,
2% to 6% by weight of plaster, and
0% to 70% by weight of limestone, slag, ash or pozzolan.

5. A microcement for injection grouts according to claim 4, which comprises:
88% by weight of Portland cement clinker,
5% by weight of plaster, and
7% by weight of limestone, slag, ash or pozzolan.

5. A microcement for injection grouts according to claim 4, which comprises:
88% by weight of Portland cement clinker,
5% by weight of plaster, and
7% by weight of limestone, slag, ash and pozzolan.

6. A microcement for injection grouts according to claims 4 and 5, wherein it presents a maximum particle size ranging between 15 and 25 microns.
